(19) United States
(12) Patent Application Publication
(10) Pub. No.: US 2009/0243871 A1
(43) Pub. Date: Oct. 1, 2009

(54) METHOD AND APPARATUS FOR PREVENTING HITTING IN A RESTRICTED ZONE DURING GAME PLAY

(76) Inventors: Kevin Botting, Elk Point (CA); Rocky Botting, Elk Point (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/442,106

(22) PCT Filed: Sep. 19, 2007
(86) PCT No.: PCT/CA07/01654

§ 371 Date: Mar. 19, 2009

Related U.S. Application Data
(60) Provisional application No. 60/845,706, filed on Sep. 19, 2006.

(30) Foreign Application Priority Data
Oct. 23, 2006 (CA) 2566065

(51) Int. Cl. G08B 21/00

(52) U.S. Cl. 340/686.6

(57) ABSTRACT

An apparatus for preventing hitting in a restricted zone during game play includes a signal generator for signalling the location of a restricted zone in a playing area contained by a barrier. A proximity detector receives the signal generated by the signal generator. An indicator indicates when the proximity detector is within the restricted zone, the signal generator and the indicator being carried by a player.

### FIELD

The present application relates to a method and apparatus for preventing hitting in a restricted zone during game play.

### BACKGROUND

Injuries in sports, such as hockey and lacrosse, occur when players are checked in to the boards that define the playing surface. Rules have been enacted for some hockey and lacrosse leagues that prohibit checking in restricted areas adjacent to the boards, but injuries continue to occur.

### SUMMARY

There is provided a method and associated apparatus for preventing hitting in a restricted zone during game play, including a signal generator for signalling the location of a restricted zone in a playing area contained by a barrier. A proximity detector receives the signal generated by the signal generator. An indicator indicates when the proximity detector is within the restricted zone, the signal generator and the indicator being carried by a player.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top plan view of the apparatus for preventing hitting in a restricted zone.

FIG. 2 is a side plan view of a hockey helmet, modified for use in accordance with the present method and apparatus.

FIG. 3 is a top plan view of an alternative apparatus for preventing hitting in a restricted zone.

### DETAILED DESCRIPTION

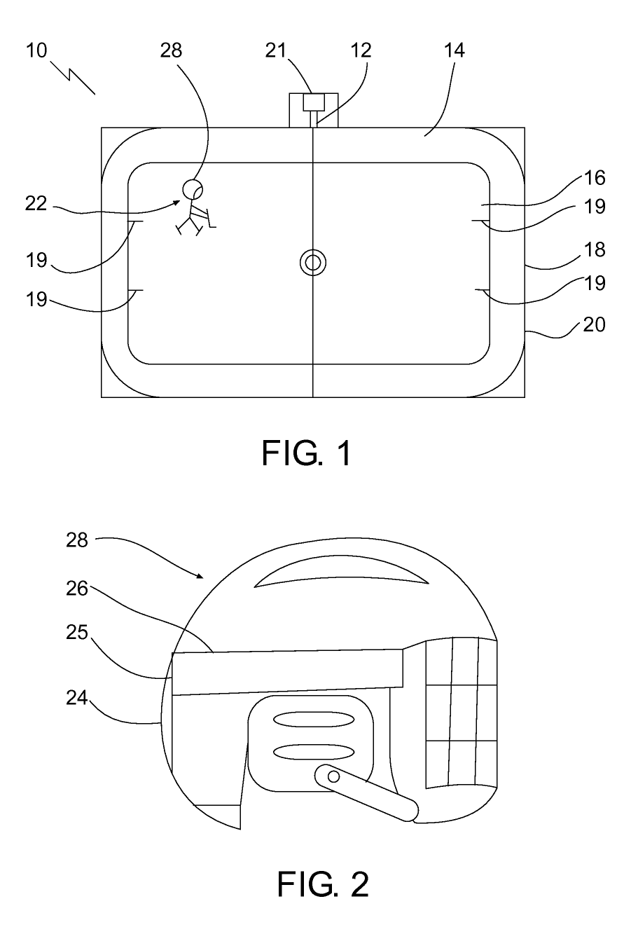

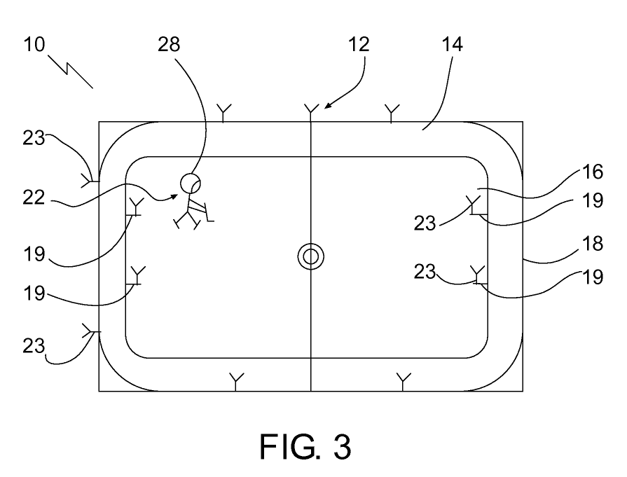

An apparatus for preventing hitting in a restricted zone during game play generally identified by reference numeral 10, will now be described with reference to FIGS. 1 and 3.

Referring to FIG. 1, apparatus 10 includes a signal generator 12 for signalling the location of a restricted zone 14 in a playing area 16 contained by a barrier 18. One example of signal generator 12 is a wire 20 acting as an antenna that follows barrier 18 about playing area 16 connected to a transmitter 21 located in the timekeepers box. A current may then be run through wire 20 by transmitter 21, such that wire 20 generates a constant magnetic field or other type of signal. The strength of the magnetic field and therefore how far it extends at a detectable level will depend on the size of the current. Alternatively, referring to FIG. 3, discrete antennas 23 may be located about barrier 18, or at other locations of high risk, such as around goals posts 19. Other designs may also be used, as will be recognized by those skilled in the art. Playing area 16 may be a hockey rink or lacrosse field in which case barrier 18 would be the boards, or any other playing area in which injury may occur when contact occurs a certain distance from barrier 18. As apparatus 10 may be implemented with any level or size of player, the position and dimensions of restricted zone 14 will depend largely on the skill and size of the players involved in the game, but will generally be about 3-6 feet from the boards. As an example, the size of restricted zone 14 may be varied by adjusting the strength of the signal generated by signal generator 12.

In the preferred embodiment, referring to FIG. 2, each player 22 (shown in FIG. 1) carries a proximity detector 24 for receiving the signal generated by signal generator 12 and an indicator 25 which indicates when proximity detector 24 is within restricted zone 14. For example, with respect to FIG. 1, proximity detector 24 may act as a switch that activates indicator 25 to indicate the presence of a magnetic field of a certain strength, which would be detected when player 22 is within restricted zone 14. Proximity detector 24 may have multiple wires in case of failure of the main wires in use. Referring again to FIG. 2, indicator 25 is preferably one or more lights 26 located on the helmet 28 of player 22. Implementation would be made in conjunction with a rule that makes it is illegal to hit a player within restricted zone 14. Once lights 26 are activated, other players are made aware that the player is in restricted zone 14, and must govern themselves accordingly. This creates a greater awareness of the restricted zone for the players and simplifies rule enforcement for referees.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. An apparatus for preventing hitting in a restricted zone during game play, comprising:
a signal generator for signalling the location of a restricted zone in a playing area contained by a barrier;
a proximity detector for receiving the signal generated by the signal generator; and
an indicator which indicates when the proximity detector is within the restricted zone, the signal generator and the indicator being carried by a player.

2. The apparatus of claim 1, wherein the restricted zone comprises a set distance from the barrier.

3. The apparatus of claim 2, wherein the barrier is boards of the playing area.

4. The apparatus of claim 1, wherein the restricted zone comprises a set distance from a goal post within the playing area.

5. The apparatus of claim 1, wherein the indicator is a light.

6. The apparatus of claim 1, wherein the signal generator is a wire.

7. The apparatus of claim 1, wherein the signal generator is a plurality of discrete antennas.

8. The apparatus of claim 1, wherein the proximity detector is carried by a player.

9. The apparatus of claim 8, wherein the proximity detector is carried on the player's helmet.
